(19) United States
(12) Patent Application Publication
(10) Pub. No.: US 2015/0002539 A1
(43) Pub. Date: Jan. 1, 2015

(54) METHODS AND APPARATUSES FOR DISPLAYING PERSPECTIVE STREET VIEW MAP

(71) Applicant: Tencent Technology (Shenzhen) Company Limited, Shenzhen (CN)

(72) Inventors: Huimin LI, Shenzhen (CN); Yongjian ZHENG, Shenzhen (CN); Kexin WU, Shenzhen (CN); Haibo WANG, Shenzhen (CN)

(73) Assignee: Tencent Technology (Shenzhen) Company Limited, Shenzhen (CN)

(21) Appl. No.: 14/290,710

(22) Filed: May 29, 2014

Related U.S. Application Data
(63) Continuation of application No. PCT/CN2014/071012, filed on Jan. 21, 2014.

(30) Foreign Application Priority Data
Jun. 28, 2013 (CN) 201310268955.0

(51) Int. Cl. G09G 5/377

(52) U.S. Cl. CPC G09G 5/377
USPC 345/629

(57) ABSTRACT

A terminal device may comprise a non-transitory processor-readable medium and a processor in communication with the storage medium. The storage medium may include a set of instructions for displaying a perspective view map to a user. The processor may be configured to execute the set of instructions to obtain a target image showing a vicinity of a target location in a perspective view along a target direction; determine a plurality of target objects that locate in the vicinity of the target location along the target direction; generate an overlaid target image by overlaying target information associated with the target objects on the target image; and display the target image overlaid with the target information.

### PRIORITY STATEMENT

This application is a continuation of International Application No. PCT/CN2014/071012, filed on Jan. 21, 2014, in the State Intellectual Property Office of the People's Republic of China, which claims the priority benefit of Chinese Patent Application No. 201310268955.0 filed on Jun. 28, 2013, the disclosures of which are incorporated herein in their entirety by reference.

### FIELD

The present disclosure generally relates to the field of map services. Specifically, the present disclosure relates to methods and apparatuses for displaying a perspective street view map.

### BACKGROUND

Perspective map services are able to provide a user with location information, which the user expects to view, and provide great convenience for the user's travels. A perspective street view map is a virtual map service and is able to display the geographic landscape more realistically and intuitively, and thus is very popular among users. A perspective street view map includes 360° horizontal and vertical perspective street view images of a city or other environments collected by a perspective street view vehicle and other tools. Perspective street view images include the real geographic landscape of each location in a city or other environments. When a perspective street view map is provided, the collected perspective street view images will be displayed to the user.

When a perspective street view map is displayed, a perspective street view image corresponding to the target location is acquired and the acquired perspective street view image is displayed so that a user learns the real geographic landscape of the target location. But because only the image of the location is displayed, the map provides the user with relatively little information of the surrounding landscapes.

### SUMMARY

According to an aspect of the present disclosure, a terminal device may comprise a non-transitory processor-readable medium and a processor in communication with the storage medium. The storage medium may include a set of instructions for displaying a perspective view map to a user. The processor may be configured to execute the set of instructions to obtain a target image showing a vicinity of a target location in a perspective view along a target direction; determine a plurality of target objects that locate in the vicinity of the target location along the target direction; generate an overlaid target image by overlaying target information associated with the target objects on the target image; and display the target image overlaid with the target information.

According to another aspect of the present disclosure, a method for displaying a perspective view map may comprise providing a terminal device to a user, wherein the terminal device includes a processor. By the processor, the method may comprise obtaining a target image showing a vicinity of a target location in a perspective view along a target direction; determining a plurality of target objects that locate in the vicinity of the target location along the target direction; generating an overlaid target image by overlaying target information associated with the target objects on the target image; and displaying the target image overlaid with the target information.

According to yet another aspect of the present disclosure, a non-transitory processor-readable storage medium may comprise a set of instructions for displaying a perspective view map on a terminal device. The set of instructions may be configured to direct a processor to perform acts of: obtaining a target image showing a vicinity of a target location in a perspective view along a target direction; determining a plurality of target objects that locate in the vicinity of the target location along the target direction; generating an overlaid target image by overlaying target information associated with the target objects on the target image; and displaying the target image overlaid with the target information.

### BRIEF DESCRIPTION OF THE DRAWINGS

The above and other features and advantages will become more apparent by describing in detail example embodiments thereof with reference to the attached drawings in which:

FIG. 1 is a flow chart of a method for displaying a perspective street view map according to example embodiments of the present disclosure;

FIG. 2 is a flow chart of a method for displaying a perspective street view map according to the example embodiments of the present disclosure;

FIG. 3(a) illustrates an example of a perspective street view image;

FIG. 3(b) illustrates an example of an overlaid perspective street view image;

FIG. 4 is a structural diagram of a first apparatus for displaying a perspective street view map according to the example embodiments of the present disclosure;

FIG. 5 is a structural diagram of a determination module according to the example embodiments of the present disclosure;

FIG. 6 is a structural diagram of a second apparatus for displaying a perspective street view map according to the example embodiments of the present disclosure;

FIG. 7 is a structural diagram of a third apparatus for displaying a perspective street view map according to the example embodiments of the present disclosure;

FIG. 8 is a structure diagram of a terminal according to the example embodiments of the present disclosure.

### DETAILED DESCRIPTIONS

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. The following detailed description is, therefore, not intended to be limiting on the scope of what is claimed.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

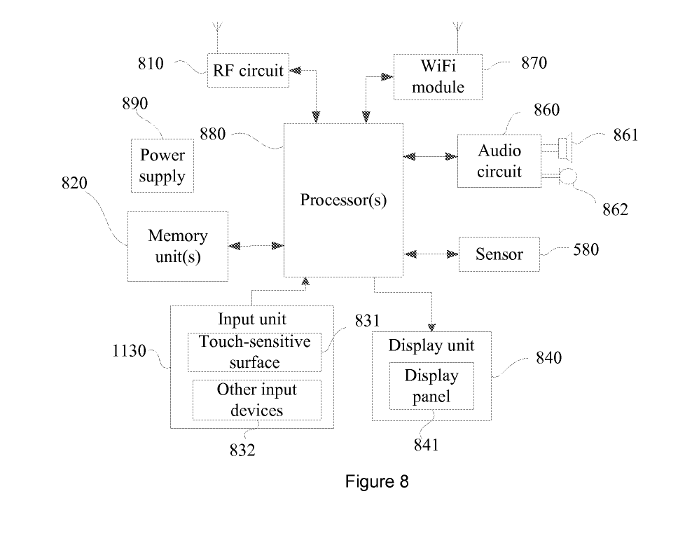

FIG. 8 illustrates a structural diagram of an intelligent terminal according to the example embodiments of the present disclosure. The intelligent terminal may be implemented as systems and/or to operate methods disclosed in the present disclosure.

The intelligent terminal may include an RF (Radio Frequency) circuit 810, one or more than one memory unit(s) 820 of computer-readable memory media, an input unit 830, a display unit 840, a sensor 850, an audio circuit 860, a WiFi (wireless fidelity) module 870, at least one processor 880, and a power supply 890. Those of ordinary skill in the art may understand that the structure of the intelligent terminal shown in FIG. 8 does not constitute restrictions on the intelligent terminal. Compared with what may be shown in the figure, more or fewer components may be included, or certain components may be combined, or components may be arranged differently.

The RF circuit 810 may be configured to receive and transmit signals during the course of receiving and transmitting information and/or phone conversation. Specifically, after the RF circuit 810 receives downlink information from a base station, it may hand off the downlink information to the processor 880 for processing. Additionally, the RF circuit 810 may transmit uplink data to the base station. Generally, the RF circuit 810 may include, but may be not limited to, an antenna, at least one amplifier, a tuner, one or multiple oscillators, a subscriber identification module (SIM) card, a transceiver, a coupler, an LNA (Low Noise Amplifier), and a duplexer. The RF circuit 810 may also communicate with a network and/or other devices via wireless communication. The wireless communication may use any communication standards or protocols available or one of ordinary skill in the art may perceive at the time of the present disclosure. For example, the wireless communication may include, but not limited to, GSM (Global System of Mobile communication), GPRS (General Packet Radio Service), CDMA (Code Division Multiple Access), WCDMA (Wideband Code Division Multiple Access), LTE (Long Term Evolution), email, and SMS (Short Messaging Service).

The memory unit 820 may be configured to store software programs and/or modules. The software programs and/or modules may be sets of instructions to be executed by the processor 880. The processor 880 may execute various functional applications and data processing by running the software programs and modules stored in the memory unit 820. The memory unit 820 may include a program memory area and a data memory area, wherein the program memory area may store the operating system and at least one functionally required application program (such as the audio playback function and image playback function); the data memory area may store data (such as audio data and phone book) created according to the use of the intelligent terminal. Moreover, the memory unit 820 may include high-speed random-access memory and may further include non-volatile memory, such as at least one disk memory device, flash device, or other volatile solid-state memory devices. Accordingly, the memory unit 820 may further include a memory controller to provide the processor 880 and the input unit 830 with access to the memory unit 820.

The input unit 830 may be configured to receive information, such as numbers or characters, and create input of signals from keyboards, touch screens, mice, joysticks, optical or track balls, which are related to user configuration and function control. Specifically, the input unit 830 may include a touch-sensitive surface 831 and other input devices 832. The touch-sensitive surface 831, also called a touch screen or a touch pad, may collect touch operations by a user on or close to it (e.g., touch operations on the touch-sensitive surface 831 or close to the touch-sensitive surface 831 by the user using a finger, a stylus, and/or any other appropriate object or attachment) and drive corresponding connecting devices according to first preset programs. The touch-sensitive surface 831 may include two portions, a touch detection device and a touch controller. The touch detection device may be configured to detect the touch location by the user and detect the signal brought by the touch operation, and then transmit the signal to the touch controller. The touch controller may be configured to receive the touch information from the touch detection device, convert the touch information into touch point coordinates information of the place where the touch screen may be contacted, and then send the touch point coordinates information to the processor 880. The touch controller may also receive commands sent by the processor 880 for execution. Moreover, the touch-sensitive surface 831 may be realized by adopting multiple types of touch-sensitive surfaces, such as resistive, capacitive, infrared, and/or surface acoustic sound wave surfaces. Besides the touch-sensitive surface 831, the input unit 830 may further include other input devices 832, such as the input devices 832 may also include, but not limited to, one or multiple types of physical keyboards, functional keys (for example, volume control buttons and switch buttons), trackballs, mice, and/or joysticks.

The display unit 840 may be configured to display information input by the user, provided to the user, and various graphical user interfaces on the intelligent terminal. These graphical user interfaces may be composed of graphics, texts, icons, videos, and/or combinations thereof. The display unit 840 may include a display panel 841. The display panel 841 may be in a form of an LCD (Liquid Crystal Display), an OLED (Organic Light-Emitting Diode), or any other form available at the time of the present disclosure or one of ordinary skill in the art would have perceived at the time of the present disclosure. Furthermore, the touch-sensitive surface 831 may cover the display panel 841. After the touch-sensitive surface 831 detects touch operations on it or nearby, it may transmit signals of the touch operations to the processor 880 to determine the type of the touch event. Afterwards, according to the type of the touch event, the processor 880 may provide corresponding visual output on the display panel 841. In FIG. 8, the touch-sensitive surface 831 and the display panel 841 realize the input and output functions as two independent components. Alternatively, the touch-sensitive surface 831 and the display panel 841 may be integrated to realize the input and output functions.

The intelligent terminal may further include at least one type of sensor 850, for example, an optical sensor, a motion sensor, and other sensors. An optical sensor may include an environmental optical sensor and a proximity sensor, wherein the environmental optical sensor may adjust the brightness of the display panel 841 according to the brightness of the environment, and the proximity sensor may turn off the display panel 841 and/or back light when the intelligent terminal may be moved close an ear of the user. As a type of motion sensor, a gravity acceleration sensor may detect the magnitude of acceleration in various directions (normally three axes) and may detect the magnitude of gravity and direction when it may be stationary. The gravity acceleration sensor may be used in applications of recognizing the attitude of the intelligent terminal (e.g., switching screen orientation, related games, and magnetometer calibration) and functions related to vibration recognition (e.g., pedometers and tapping); the intelligent terminal may also be configured with a gyroscope, barometer, hygrometer, thermometer, infrared sensor, and other sensors.

An audio circuit 860, a speaker 861, and a microphone 862 may provide audio interfaces between the user and the intelligent terminal. The audio circuit 860 may transmit the electric signals, which are converted from the received audio data, to the speaker 861, and the speaker 861 may convert them into the output of sound signals; on the other hand, the microphone 862 may convert the collected sound signals into electric signals, which may be converted into audio data after they are received by the audio circuit 860; after the audio data may be output to the processor 880 for processing, it may be transmitted via the RF circuit 810 to, for example, another terminal; or the audio data may be output to the memory unit 820 for further processing. The audio circuit 860 may further include an earplug jack to provide communication between earplugs and the intelligent terminal.

WiFi may be a short-distance wireless transmission technology. Via the WiFi module 870, the intelligent terminal may help users receive and send emails, browse web pages, and visit streaming media. The WiFi module 870 may provide the user with wireless broadband Internet access.

The processor 880 may be the control center of the intelligent terminal. The processor 880 may connect to various parts of the entire intelligent terminal utilizing various interfaces and circuits. The processor 880 may conduct overall monitoring of the intelligent terminal by running or executing the software programs and/or modules stored in the memory unit 820, calling the data stored in the memory unit 820, and executing various functions and processing data of the intelligent terminal. The processor 880 may include one or multiple processing core(s). The processor 880 may integrate an application processor and a modem processor, wherein the application processor may process the operating system, user interface, and application programs, and the modem processor may process wireless communication.

The intelligent terminal may further include a power supply 890 (for example a battery), which supplies power to various components. The power supply may be logically connected to the processor 880 via a power management system so that charging, discharging, power consumption management, and other functions may be realized via the power management system. The power supply 890 may further include one or more than one DC or AC power supply, a recharging system, a power failure detection circuit, a power converter or inverter, a power status indicator, and other random components. Further, the intelligent terminal 800 may also include a camera, Bluetooth module, etc., which are not shown in FIG. 8.

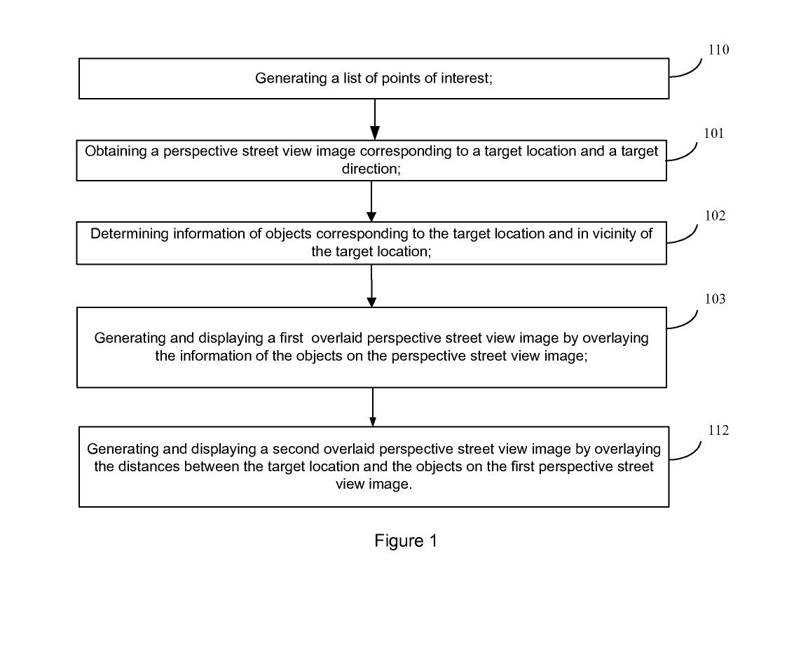

FIG. 1 is a flow chart of a method for displaying a perspective street view map according to example embodiments of the present disclosure. The method may be implemented in an intelligent terminal (hereinafter “terminal”), such as the terminal 800 shown in FIG. 8. For example, the method may be stored in the memory unit 820 as a set of instructions and executed by the processor 880. According to the method, the terminal may perform the following steps:

Step 101: obtaining a perspective street view image corresponding to a target location and target direction to be displayed on an interface of a terminal.

Step 102: determining information of objects in a vicinity of the target location corresponding to the target location and the target direction.

Along the target direction at the target location, there may have a plurality of objects nearby. The objects may be points of interest, i.e., objects close to the target location along the target direction that a user is concerned about in the map, including but not limited to buildings, streets, attractions, stores, and gas stations. The perspective street view image may be obtained based on the target direction of the target location. Different target direction at the same location may result in different perspective street view image, thereby different objects along the target direction.

The determination of the information of the objects corresponding to the target location may include determining a longitude and a latitude of the target location and determining the information of the objects according to the longitude and latitude of the target location.

The determination of the information of the objects may include determining objects (i.e., the target object) of which distances to the target location are less than a first preset distance according to the longitude and latitude of the target location, and then determining that the information of the candidate points is the information of the objects corresponding to the target location.

Further, the method may include:

Step 110: generating, in advance, a list of objects. The list of objects may include information of at least one object. The information of each object may include the longitude and latitude information of the object, the address of the object, and the name of the object.

Accordingly, the determination of the information of the objects in step 102 may include retrieving the information of the objects corresponding to the target location from the list of objects.

Step 103: generating a first overlaid perspective street view image by overlaying the information of the objects on the perspective street view image, and displaying the first overlaid perspective street view image.

Step 112: generating a second overlaid perspective street view image by overlaying the distances between the target location and the objects on the first overlaid perspective street view image and displaying the second overlaid perspective street view image.

To summarize, by overlaying the information (and/or distances) of the objects corresponding to the target location on the perspective street view image corresponding to the target location and displaying the perspective street view image overlaid with the information (and/or distance) of the objects, the method may provide to a user with more information while displaying the perspective street view map.

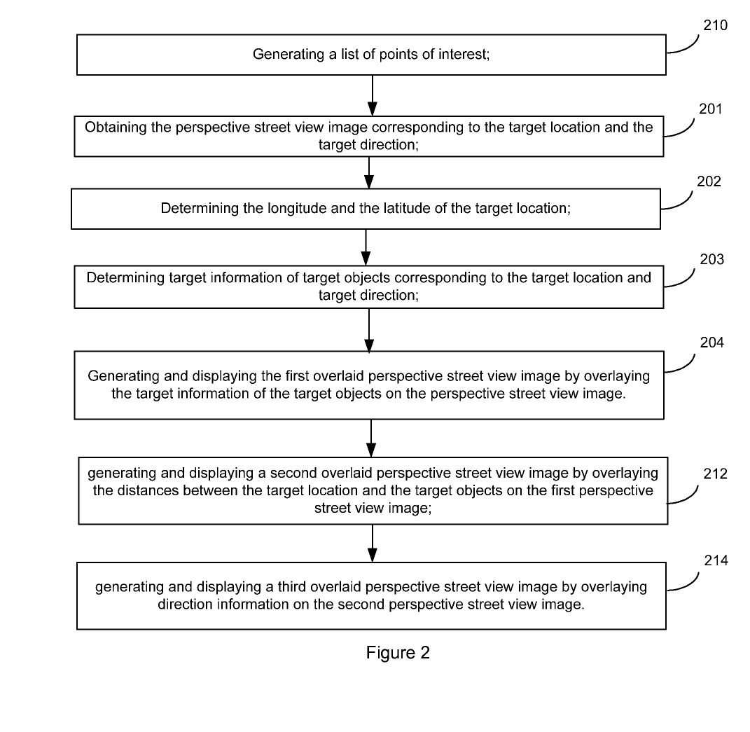

FIG. 2 is a flow chart of a method for displaying a perspective street view map according to the example embodiments of the present disclosure. The method may be implemented in an intelligent terminal (hereinafter “terminal”), such as the terminal 800 shown in FIG. 8. For example, the method may be stored in the memory unit 820 as a set of instructions and executed by the processor 880. The terminal may include a display screen to display the perspective street view image. The terminal may be a smart phone, a tablet PC, a notebook computer, an MP4 (Moving Picture Experts Group Audio Layer IV) player, a laptop computer, a desktop computer, a navigator (GPS), or a device that incorporate hardware of software of the above equipment. According to the method, the terminal may perform the following steps:

Step 201: obtaining a perspective street view image corresponding to the target location to be displayed in the interface of the terminal and the target direction in the target location.

With regard to this step, the target location may be the target location selected according to user requirements, and may also be the system default target location. Perspective street view images may be perspective street view images of a spot of a city or other environments at any of the 360° angle along horizontal direction and vertically direction. The perspective street view images may be collected in advance by a perspective street view vehicle and/or other suitable tools. Such perspective street view images may be in the format of high-definition images and include the panoramic images that can be seen from each location in a city or other environments. The collected perspective street view images may be saved in the terminal and may also be saved in a server. The server may be configured to send the perspective street view images to the terminal over Internet, wired or wireless. The corresponding relation between the collected perspective street view image and its corresponding location may also be recorded.

The terminal may adopt different ways to obtain a perspective street view image according to different memory locations that the collected perspective street view image is saved. For example, if the perspective street view image is saved in a local memory in the terminal, the terminal may directly acquire the perspective street view image corresponding to the target location from the perspective street view images saved in the terminal; if the collected perspective street view image is saved in the server, the terminal may transmit the target location to the server, and the server may acquire the perspective street view image corresponding to the target location from the perspective street view images saved in the server and send the perspective street view image corresponding to the target location to the terminal.

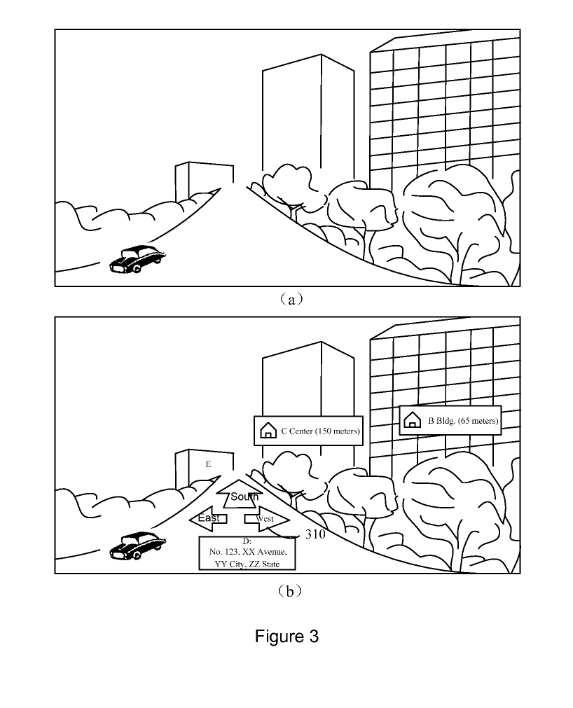

For example, when using a perspective street view map, the user may be in a location A moving towards north. Accordingly, the terminal may display to a user the perspective street view image corresponding to location A and facing towards north. To this end, the location A may be selected as the target location on the terminal. The terminal may transmit location A (e.g., the longitude and latitude coordinate of location A) and direction north to the server. In response, the server may acquire the perspective street view image corresponding to location A and facing to north from the perspective street view images saved in the server locally or from a remote memory to which the server may access. An example perspective street view image corresponding to location A is shown in FIG. 3(a).

202: determining the longitude and latitude of the target location.

With regard to this step, the target location may have coordinates, which may include a latitude coordinate (hereinafter “latitude”) and a longitude coordinate (hereinafter “longitude”). The longitude and latitude of the target location may be used to define the accurate location of the target location. A Global Positioning System (GPS) may be used to real-time determine the longitude and latitude of the target location.

Alternatively, the longitude and latitude of the target location may be determined by using other methods. For example, the server may first generate a grid over the region that the user locates before the user request his/her position coordinates, wherein the grid includes a plurality of sampling locations. The finer the grid is the more sampling locations in the grid. The server may use the GPS system to measure the longitude and latitude of each location in the plurality of locations in the region. The longitude and latitude information of the plurality sampling positions in the grid may be pre-saved in the server or in the local memory in the terminal. When the user needs his/her location coordinate, the terminal may either obtain the coordinate directly from the local memory, or the server may obtain the coordinate directly from its memory and send it to the terminal. Accordingly, no real-time communication with the GPS system is needed.

Step 203: determining the information of the objects corresponding to the target location according to the longitude and latitude of the target location.

The objects are points of interest, i.e., points that a user is more concerned about in the map, including but not limited to buildings, streets, attractions, stores, and gas stations. For example, on a road, the objects may comprise buildings on both sides of a road and the overpass above such road that the target location locates.

Because a perspective street view image may only show limited geographic scope (e.g., only limited buildings, stores, streets, attractions, and gas stations near the target location may appear in the perspective street view image), only a limited number of objects in a vicinity of the target location along the direction that the perspective street view image faces towards is needed to obtain at one time. Thus the terminal may only need the objects (hereinafter “target objects”) within a first preset distance and along the target direction from the target location to be displayed together with the perspective street view image. The first preset distance is determined so that all the target object appear in the perspective street view image and/or every object appear in the perspective street view image is a target object.

Accordingly, step 203 may include: determining the target objects according to the longitude and latitude of the target location and the target direction, and determining that the information of the target objects is the information (hereinafter “target information”) corresponding to the target location.

When determining the target objects, the terminal may calculate distances between the target location and objects nearby, according to the longitude and latitude of the target location and the longitude and latitude of each object in the map. The terminal may then compare the calculated distances with the first preset distance. The terminal may select the objects of which the corresponding distance is less than the first preset distance as the target objects. Alternatively, the calculation and comparison may be conducted by the server, and the server may send the calculation results to the terminal to reduce the work load of the terminal.

The longitude and latitude of each object may be determined by using the same method as that of the target location. When calculating the distance between the target location and a point of interest in the map, the terminal may use following formula:

d=111.12 cos {1/[sin θA sin θB+cos λA cos λB cos(λB−λA)]},

where d is the distance between the target location A and the object B; θA is the longitude of the target location A; λA is the latitude of the target location A; θB is the longitude of the object B; λB is the latitude of the object B.

After the distance between the target location and each object in the map is calculated and obtained, the calculated and obtained distance may be compared with the first preset distance. The terminal may select the objects which have distances from the target location lesser than the first preset distance. The specific length of the first preset distance may be set according to actual circumstances. For example, the first preset distance may be set as 100 meters, 150 meters, or 200 meters.

Furthermore, in order to determine the information of the objects corresponding to the target location, the terminal may execute step 210 to generate the list of objects in advance. The list of objects may include information of at least one object; the information of each object may include the longitude and latitude of each object, the address of each object, and the name of each object. Besides, other information may also be included, such as the category and attribute of each object. For example, information of an object B may have a format as “longitude and latitude∥address∥name∥category∥attribute”. For example, the information of an object B may be: 113.9556654, 22.53968667∥No. 3 Main Street, XY City, Va. (state)∥Convention Center∥Government Organization∥Point of Interest. In addition to textual information, the information of each object may further include visual audio information. For example, the information may include audio clips speaking out the address, name, category, attribute of the object. The information may also include one or more image outlining the object. The image may have a flashing effect, so that if the image is added on a corresponding perspective street view image, the corresponding object therein may be flashing or outstanding to a user.

To generate the list of objects, the information of each object may be acquired in advance by on-site data measurement and collection. After that, the measured data for information of each object may be added to the list of objects. Information of objects may also be collected added to the list of objects through reports from users. During the course of use, the user may also supplement in real time the information of objects, which is not included in the list of objects. The terminal may add the information of objects supplemented by the user to the list of objects to keep updating the list of objects.

The list of objects may be saved in the terminal locally and/or may be saved in a server. For example, during the course of use, the user may find that the list of objects does not have information of Building B and thus reports to the terminal the information of the object, such as the longitude and latitude, address, and name of Building B. The terminal may transmit the reported information to the server. After receiving the reported information, the server may add the information of the object reported by the user to the list of objects.

Based on the list of objects, the terminal or the server may determine the information of objects corresponding to the target location according to the longitude and latitude of the target location. To this end, the terminal or server may determine the information of the target objects corresponding to the target location in the list of objects according to the longitude and latitude of the target location. When the distances between the target location and each object nearby are calculated, the distances between the target location and the objects included in the list of objects may be calculated and the longitude and latitude of each object may be acquired directly from the list of objects configured in advance.

For example, if location A is the target location, which is the point that has a street view shown in FIG. 3(b), the perspective street view image corresponding to location A may first be acquired according to step 201 and the longitude and latitude corresponding to location A is acquired according to step 202. The list of objects may include the information of four objects, i.e., B, C, D, and E. According to the longitude and latitude of location A and the longitude and latitude of the object B, the distance between location A and the object B may be 65 meters, which is less than a first preset distance of 200 meters. Accordingly, the object B may be determined as a target object, and the information of the object B may be determined as target information corresponding to location A. Similarly, the distance between location A and the object C may be calculated to be 150 meters, which is also less than the first preset distance of 200 meters. Accordingly, the object C may also be determined as a target object corresponding to point A, and the information of the object C may also be determined as target information corresponding to location A. The distance between location A and the object D may be calculated to be 0 meter, which is less than the first preset distance of 200 meters. Accordingly, point D may also be determined as a target object, and the information of the point D is determined to be target information corresponding to location A. The distance between location A and the object E, however, may be calculated to be 300 meters, which is greater than the first preset distance of 200 meters. Thus the object E may not be determined as a target object, and the information of the object E may not be determined to be target information corresponding to location A.

Step 204: generating the first overlaid perspective street view image by overlaying the target information of the target objects on the perspective street view image, and displaying the first overlaid perspective street view image to the user.

With regard to this step, the target information of the target objects may be overlaid on the perspective street view image. At the time of overlaying, the target information may be overlaid onto the corresponding locations of the target objects in the perspective street view image so that each piece of target information appears over the right target object. Since each piece of the target information includes the longitude and latitude, address, name, and other information of the corresponding target object, when the target information is overlaid on the perspective street view image, all or part of the contents included in the target information may be overlaid on the perspective street view image. For example, only the address of the target object may be overlaid on the perspective street view image or only the name of the target object is overlaid on the perspective street view image.

Further, based on a predetermined condition, the method may also distinguish a target object from other target objects. For example, the predetermined condition may be a second preset distance shorter than the first preset distance, and the method may distinguish the target object within the second preset distance of the target location from other target objects that are farer than the second preset distance by overlaying different part of the target information or displaying the corresponding target information in a different format, color, and/or font. For example, the second preset distance may be 5 meters, or a distance that the user will arrive within 3 second accord to a speed of the user. Accordingly, in FIG. 3(b), only object D, which has 0 meter distance from the target location A, may be within the second preset distance. Correspondingly, the terminal may overlay only the name of the objects B and C but may overlay both the name and address of the object D over the perspective street view image of the target point A to specially inform the user where the user will arrive in the next instance. The information of object D may be displayed at the center bottom of the perspective street view image. Further, the information of object D may be flashy to remind the user what place he/she is approaching. Similarly, a flashing image or a flashing outline of object D may be included in the information of the object D and may be displayed when the object D is within the second preset distance.

After the overlaying is completed, the first overlaid perspective street view image may be displayed on the terminal, so that the user who acquires the perspective street view image of the target location may also acquire the information of the target objects from the perspective street view image.

Step 212: generating and displaying a second overlaid perspective street view image by overlaying the distances between the target location and the objects on the first perspective street view image. When displaying the perspective street view image, the method may further include displaying the perspective street view image overlaid with the target information of the objects and the distances of the target objects. Thus, the user may also be informed about the distances between the target location and the target objects displayed in the perspective street view image.

Step 214: besides the aforementioned overlaying target information on the perspective street view image, other information may also be overlaid and displayed on the perspective street view image.

For example, direction information 310 may also be overlaid on the second overlaid perspective street view image. The overlaying location of the direction information 310 may be at will. For example, four directions, North, South, East, and West, may be overlaid in a perspective manner with arrows pointing towards the four directions. In another example, an arrow pointing to the forward direction of the user may be overlaid in the second perspective street view image, along with a textual description of the direction of the arrow (e.g., North, South, or Northeast, etc.). Alternatively, the direction information 310 may also be added over the first perspective street view image or the original perspective street view image. After overlaying the direction information, the third perspective street view image may be displayed to the user.

When displaying the first, second, and/or third perspective street view image on different terminals, different display methods corresponding to the terminals may be used. For example, a flash method may be used for displaying on a desktop or notebook computer; and a method of HTML5 (Hypertext Markup Language 5) or client GUI (Graphical User Interface) may be used for display on a cell phone terminal.

For example, in FIG. 3(b), after determining the information of the object B, object C, and object D corresponding to the target location A according to step 203, the name of the object B and the distance between location A and the object B, which are included in the target information of the object B, are overlaid in the location corresponding to the object B in the perspective street view image; the name of the object C and the distance between location A and the object C, which are included in the information of the object C, are overlaid in the location corresponding to the object C in the perspective street view image; the address of the object D, which is included in the information of the object D, is overlaid in the location corresponding to the object D in the perspective street view image; the direction information is also overlaid in the perspective street view image.

According to the example embodiments of the present disclosure, the terminal may update the perspective street view image at a predetermined frequency according to a user's instruction or according to the target location of the terminal device. For example, if the user operates the terminal to see street views around the target location, the terminal may update the perspective street view image periodically and the target objects may be calculated to rotate together with the perspective view image to generate a virtual effect that the user is standing at the target position and look around. In another example, if the user is moving forward and using the terminal to view a perspective map, the terminal may generate and update the new perspective street view image to the user to create a virtual effect that the perspective view of the map is moving forward. For example, the new perspective street view image may be generated according to the change of the coordinate (longitude and latitude) of the target location. Correspondingly, new target objects moving into the first preset distance and new target information may be added in the perspective street view image and old target objects moving out of the first preset distance may be eliminated from the newly generated perspective street view image.

To summarize, by overlaying the target information on the perspective street view image corresponding to the target location and displaying the overlaid perspective street view image, the method may provide to a user with more information while displaying the perspective street view map.

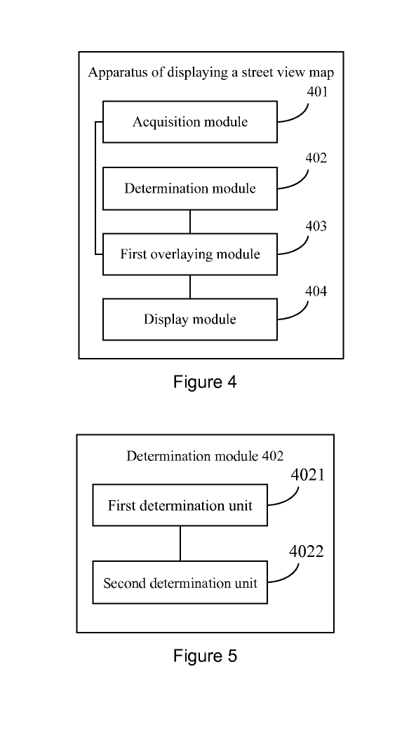

FIG. 4 is a structural diagram of a first apparatus for displaying a perspective street view map according to the example embodiments of the present disclosure. The apparatus may include: an acquisition module 401, configured to acquire the perspective street view image corresponding to the target location; a determination module 402, configured to determine the target information corresponding to the target location; a first overlaying module 403, configured to generate a first perspective street view image by overlaying the target information as determined by the determination module 402 on the perspective street view image; and a display module 404, configured to display the first perspective street view image.

FIG. 5 is a structural diagram of the determination module 402 according to the example embodiments of the present disclosure. The determination module 402 may include: a first determination unit 4021, configured to determine the longitude and latitude of the target location; a second determination unit 4022, configured to determine the target information of the target objects corresponding to the target location according to the longitude and latitude of the target location as determined by the first determination unit 4021.

For example, the second determination unit 4022 may be configured to determine the objects that have distances between which and the target location less than the first preset distance, according to the longitude and latitude of the target location as determined by the first determination unit 4021, identify these object as target objects, and then determine that the corresponding information of the target objects, identify the information as the target information.

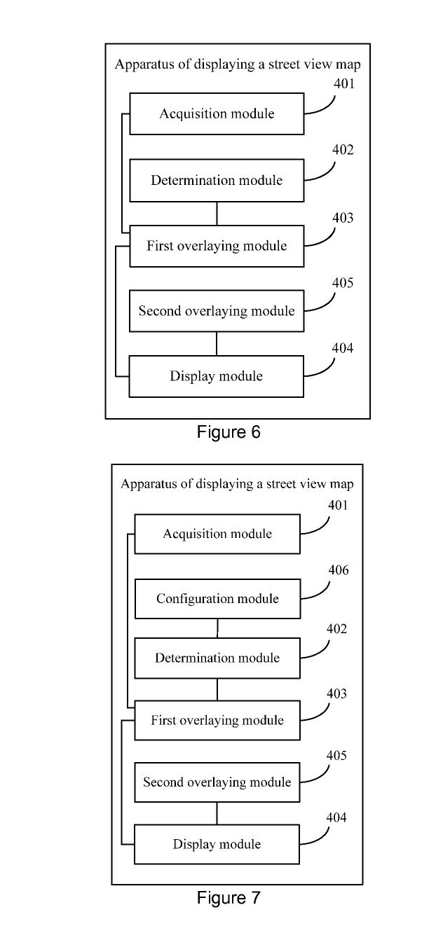

FIG. 6 is a structural diagram of a second apparatus for displaying a perspective street view map according to the example embodiments of the present disclosure. In addition to the elements in FIG. 4, the apparatus in FIG. 6 may further include: a second overlaying module 405, configured to generate the second overlay perspective street view image by overlaying the distances between the target location and the target objects on the first overlaid perspective street view image. The second overlaying module may also be configured to generate the third overlaid perspective street view image. Accordingly, the display module 404 may be configured display the second or the third overlaid perspective street view image.

FIG. 7 is a structural diagram of a third apparatus for displaying a perspective street view map according to the example embodiments of the present disclosure. In addition to the elements in FIG. 6, the apparatus in FIG. 7 may further include: a configuration module 406, configured to generate in advance a list of objects. The list of objects may include information of at least one object; the information of each object may include at the longitude and latitude of each object, the address of each object, and the name of each object. Accordingly, the determination module 402 in FIG. 7 may be configured to determine the information of the objects corresponding to the target location in the list of objects generated by the configuration module 406.

To summarize, by overlaying the information of the objects corresponding to the target location on the perspective street view image corresponding to the target location and displaying the perspective street view image overlaid with the information of the objects, the apparatus may provide to the user with more information while displaying the perspective street view map.

According to the example embodiments of the present disclosure, the above disclosed methods may be implemented in a terminal. The terminal may include an apparatus of displaying a perspective street view map as provided by the aforementioned example embodiments. By overlaying the target information on the perspective street view image corresponding to the target location and displaying the perspective street view image overlaid with the information of the objects, the terminal may provide to its user with more information while displaying the perspective street view map. Accordingly, the user not only may be able to acquire a perspective street view map, but also may be able to acquire the information of the objects in the map, the distances between the target location and the objects, and other information in the perspective street view map.

The terminal may adopt a structure shown in FIG. 8. For example, the display unit 840 of the terminal 800 may be a touch screen. The memory unit 820 may include one or more programs saved therein, wherein the one or more programs are stored in a form of instructions executable by the processor 880. The processor 880 may be configured to execute the instructions to: acquire a perspective street view image corresponding to the target location; determine the target information of the target objects corresponding to the target location; and overlay the target information of the target objects on the perspective street view image and displaying the resulting first perspective street view image.

The processor 880 may be further configured to execute the instructions to determine the longitude and latitude of the target location and determining the information of the target objects corresponding to the target location according to the longitude and latitude of the target location.

The processor 880 may be further configured to execute the instructions to determine the target objects, of which the distances to the target location are less than the first preset distance, according to the longitude and latitude of the target location, and determining that the information of the target objects as the target information of the target objects corresponding to the target location.

The processor 880 may be further configured to execute the instructions to overlay the target information as well as the distances between the target location and the target objects on the perspective street view image to generate the first and second perspective street view images, respectively; and display the first and second perspective street view images, which may include: display the perspective street view image overlaid with the information of the objects and the distances between the target location and the objects, wherein the target objects are points that a user is concerned about in the map, including buildings, streets, attractions, stores, and gas stations.

The processor 880 may be further configured to execute the instructions to generate in advance a list of objects, wherein the list of objects may include information of at least one object, the information of each object may include at a minimum the longitude and latitude of each object, the address of each object, and the name of each object; and determine the information of the objects corresponding to the target location in the list of objects generated in advance.

To summarize, by overlaying the information of the objects corresponding to the target location on the perspective street view image corresponding to the target location and displaying the perspective street view image overlaid with the information of the objects, the terminal may provide to a user with more information while displaying the perspective street view map.

According to the example embodiment of the present disclosure, there is also provided a computer-readable memory medium. The computer-readable memory medium may be the computer-readable memory medium included in the memory unit 820 in the aforementioned embodiments; it may also be an independent computer-readable memory medium, which is not installed in the terminal 800. The computer-readable memory medium may have one or more programs saved therein. The one or more programs may be instructions executable by the processor 880 and may be configured to direct the processor 880 to execute a method of displaying a perspective street view map. The method may include: acquiring a perspective street view image corresponding to the target location; determining the target information of the target objects corresponding to the target location; overlaying the target information on the perspective street view image and displaying the perspective street view image overlaid with the target information.

The instructions stored in the memory unit 820 may further direct the processor 880 to carry out the operation of determining the longitude and latitude of the target location and determining the information of the objects corresponding to the target location according to the longitude and latitude of the target location.

The determining of the information of the objects corresponding to the target location according to the longitude and latitude of the target location may include: determining the objects that have distances to the target location are less than the first preset distance as target objects, according to the longitude and latitude of the target location, and determining that the information of the target objects is the target information corresponding to the target location.

Before displaying the perspective street view image overlaid with the information of the objects, the instructions stored in the memory unit 820 may further direct the processor 880 to carry out the operation of overlaying the distances between the target location and the target objects on the perspective street view image; and displaying the perspective street view image overlaid with the information of the objects, which may include: displaying the perspective street view image overlaid with the information of the target objects and the distances between the target location and the target objects. Wherein, the target objects may be points that a user is concerned about in the map, including buildings, streets, attractions, stores, and gas stations.

The instructions stored in the memory unit 820 may further direct the processor 880 to carry out the operation of generating in advance a list of objects, wherein the list of objects may include information of at least one object, the information of each object may include at a minimum the longitude and latitude of each object, the address of each object, and the name of each object.

The determining of the information of the objects corresponding to the target location may include: determining the information of the objects corresponding to the target location in the list of objects configured in advance.

To summarize, by overlaying the information of the target objects on the perspective street view image corresponding to the target location and displaying the perspective street view image overlaid with the information of the objects, the computer-readable memory medium may provide to a user with more information while displaying the perspective street view map.

According to the example embodiments of the present disclosure, there is a graphical user interface. The graphical user interface may be used on a terminal. The terminal may include a touch screen display, a memory unit, and one or more processors configured to execute one or more programs, which are saved in one or more memories as instructions executable by the one or more processors. The graphical user interface may be configured to enable the terminal and/or the one or more processors to perform the acts of: acquiring a perspective street view image corresponding to the target location; determining the information of the objects corresponding to the target location; and overlaying the information of the objects on the perspective street view image and displaying the perspective street view image overlaid with information of the objects. Wherein, objects may be points that a user is concerned about in the map, including buildings, streets, attractions, stores, and gas stations.

To summarize, by overlaying the information of the objects corresponding to the target location on the perspective street view image corresponding to the target location and displaying the perspective street view image overlaid with the information of the objects, the graphical user interface may provide to a user with more information while displaying the perspective street view map.

When the apparatuses as provided in the example embodiments display a perspective street view map, the aforementioned functional modules are only examples of realizing functions in the methods of the present disclosure. In practical applications, it is feasible to allocate the aforementioned functions to be completed by different functional modules according to requirements, i.e., the internal structure of the apparatus may be divided into different functional modules to complete all or some of the functions described above. Moreover, the apparatuses and terminals of displaying a perspective street view map as provided in the aforementioned example embodiments may implement same concepts for displaying a perspective street view map as the methods disclosed above.

Those of ordinary skill in the art may understand that all or some of the steps of the aforementioned embodiments may be completed through hardware and may also be completed through programs which instruct related hardware; The programs may be saved in a type of computer-readable memory medium and the aforementioned memory medium may be read-only memory, a disk or a compact disk, etc.

While example embodiments of the present disclosure relate to apparatuses and methods for displaying a perspective street view map, the apparatuses and methods may also be applied to other Applications. The present disclosure intends to cover the broadest scope of systems and methods for content browsing, generation, and interaction.

Thus, example embodiments illustrated in FIGS. 1-8 serve only as examples to illustrate several ways of implementation of the present disclosure. They should not be construed as to limit the spirit and scope of the example embodiments of the present disclosure. It should be noted that those skilled in the art may still make various modifications or variations without departing from the spirit and scope of the example embodiments. Such modifications and variations shall fall within the protection scope of the example embodiments, as defined in attached claims.

We claim:

1. A terminal device, comprising:
a non-transitory processor-readable medium including a set of instructions for displaying a perspective view map to a user; and
a processor in communication with the medium, the processor being configured to execute the set of instructions that:
obtain a target image showing a vicinity of a target location in a perspective view along a target direction;
determine a plurality of target objects that are located in the vicinity of the target location along the target direction;
generate an overlaid target image by overlaying target information associated with the target objects on the target image; and
display the target image overlaid with the target information.

2. The terminal device of claim 1, wherein the target information comprises at least one of a coordinate, a name, an address, a category, an attribute, a flashing outline, or an audio clip thereof associated with each of the plurality of target objects; and
wherein the terminal device comprises at least one of a mobile phone, a laptop computer, a desktop computer, or a GPS device.

3. The terminal device of claim 1, wherein to determine the plurality of target objects the processor is further configured to execute the at least one set of instructions to:
determine a coordinate of the target location;
determine a plurality of candidate objects that are located in the vicinity of the target location along the target direction; and for each candidate object in the plurality of candidate objects:
determine a distance between the target location and the candidate object; and
select the candidate object as a target object when the distance is less than a first preset distance.

4. The terminal device of claim 3, wherein to generate the overlaid target image the processor is configured to execute the set of instructions to:
overlay the distances associated with the plurality of target objects on the perspective street view image.

5. The terminal device of claim 3, wherein the processor is configured to execute the set of instructions to:
select an arriving object from the plurality of target objects,
wherein the arriving object is closest to the target location among the plurality of target objects and has a distance less than a second preset distance, and
wherein the second preset distance is shorter than the first preset distance; and
overlay more information associated with the arriving object than the information associated with the remaining target objects in the plurality of target objects.

6. The terminal device of claim 3, wherein the processor is further configured to execute the set of instructions to:
update the target location and the target direction periodically;
update the target image periodically based on the updated target location and the updated target direction;
update the plurality of target objects periodically based on the updated target location and target direction; and
update the overlaid target image periodically based on the updated target image and the updated plurality of target objects.

7. The terminal device of claim 3, wherein each of the plurality of candidate objects is an object that the user is concerned about in a map, wherein the object includes at least one of a building, a street, an attraction, a store, or a gas station.

8. A method for displaying a perspective view map, comprising:
providing a terminal device to a user, wherein the terminal device includes a processor;
obtaining, by the processor, a target image showing a vicinity of a target location in a perspective view along a target direction;
determining, by the processor, a plurality of target objects that locate in the vicinity of the target location along the target direction;
generating, by the processor, an overlaid target image by overlaying target information associated with the target objects on the target image; and
displaying the target image overlaid with the target information.

9. The method of claim 8, wherein the target information comprises at least one of a coordinate, a name, an address, a category, an attribute, a flashing outline, or an audio clip thereof associated with each of the plurality of target objects; and
wherein the terminal device comprises at least one of a mobile phone, a laptop computer, a desktop computer, a GPS device, or a MP4 player.

10. The method of claim 8, wherein the determining of the plurality of target objects comprises:
determining a coordinate of the target location;
determining a plurality of candidate objects that locate in the vicinity of the target location along the target direction;
for each candidate object in the plurality of candidate objects:
determining a distance between the target location and the candidate object; and
selecting the candidate object as a target object when the distance is less than a first preset distance.

11. The method of claim 10, wherein the generating of the overlaid target image further comprises:
overlaying the distances associated with the plurality of target objects on the perspective street view image.

12. The method of claim 10, further comprising:
selecting, by the a processor, an arriving object from the plurality of target objects,
wherein the arriving object is closest to the target location among the plurality of target objects and has a distance less than a second preset distance, and
wherein the second preset distance is shorter than the first preset distance; and
overlaying more information associated with the arriving object than the information associated with the remaining target objects in the plurality of target objects.

13. The method of claim 10, further comprising:
updating, by the processor, the target location and the target direction periodically;
updating, by the processor, the target image periodically based on the updated target location and the updated target direction;
updating, by the processor, the plurality of target objects periodically based on the updated target location and target direction; and
updating, by the processor, the overlaid target image periodically based on the updated target image and the updated plurality of target objects.

14. The method of claim 10, wherein each of the plurality of candidate objects is an object that the user is concerned about in a map, wherein the object includes at least one of a building, a street, an attraction, a store, or a gas station.

15. A non-transitory processor-readable storage medium comprising a set of instructions for displaying a perspective view map on a terminal device, the set of instructions is configured to direct a processor to perform acts of:
obtaining a target image showing a vicinity of a target location in a perspective view along a target direction;
determining a plurality of target objects that locate in the vicinity of the target location along the target direction;
generating an overlaid target image by overlaying target information associated with the target objects on the target image; and
displaying the target image overlaid with the target information.

16. The storage medium of claim 15, wherein the target information comprises at least one of a coordinate, a name, an address, a category, an attribute, a flashing outline, or an audio clip thereof associated with each of the plurality of target objects;
wherein each of the plurality of target objects is an object that the user is concerned about in a map, wherein the object includes at least one of a building, a street, an attraction, a store, or a gas station; and
wherein the terminal device comprises at least one of a mobile phone, a laptop computer, a desktop computer, or a GPS device.

17. The storage medium of claim 15, wherein the determining of the plurality of target objects comprises:
determining a coordinate of the target location;
determining a plurality of candidate objects that locate in the vicinity of the target location along the target direction;
for each candidate object in the plurality of candidate objects:
determining a distance between the target location and the candidate object; and
selecting the candidate object as a target object when the distance is less than a first preset distance.

18. The storage of claim 17, wherein the generating of the overlaid target image further comprises:
overlaying the distances associated with the plurality of target objects on the perspective street view image.

19. The storage of claim 17, wherein the set of instructions is further configured to direct the processor to perform acts of:
selecting an arriving object from the plurality of target objects,
wherein the arriving object is closest to the target location among the plurality of target objects and has a distance less than a second preset distance, and
wherein the second preset distance is shorter than the first preset distance; and
overlaying more information associated with the arriving object than the information associated with the remaining target objects in the plurality of target objects.

20. The storage of claim 17, wherein the set of instructions is further configured to direct the processor to perform acts of:
updating the target location and the target direction periodically;
updating the target image periodically based on the updated target location and the updated target direction;
updating the plurality of target objects periodically based on the updated target location and target direction; and
updating the overlaid target image periodically based on the updated target image and the updated plurality of target objects.
